(19) United States
(12) Patent Application Publication
(10) Pub. No.: US 2021/0144678 A1
(43) Pub. Date: May 13, 2021

(54) TERMINAL APPARATUS, BASE STATION APPARATUS, COMMUNICATION METHOD, AND INTEGRATED CIRCUIT

(71) Applicants: SHARP KABUSHIKI KAISHA, Sakai City, Osaka (JP); WASEDA UNIVERSITY, Tokyo (JP)

(72) Inventors: HIROMICHI TOMEBA, Sakai City, Osaka (JP); HIDEO NAMBA, Sakai City, Osaka (JP); TAKASHI ONODERA, Sakai City, Osaka (JP); YASUHIRO HAMAGUCHI, Sakai City, Osaka (JP); FUMIAKI MAEHARA, Tokyo (JP)

(21) Appl. No.: 16/492,491

(22) PCT Filed: Mar. 5, 2018
(86) PCT No.: PCT/JP2018/008283

§ 371 Date: Sep. 9, 2019

(30) Foreign Application Priority Data
Mar. 15, 2017 (JP) 2017-050611

(51) Int. Cl. H04W 72/02; H04W 74/08; H04W 72/14; H04W 72/04; H04L 5/00

(52) U.S. Cl. CPC H04W 72/02; H04W 74/08; H04L 5/0053; H04W 72/0453; H04W 72/14

(57) ABSTRACT

Provided is a terminal apparatus for communicating with a base station apparatus by using a plurality of subcarriers by a grant free access scheme, the terminal apparatus includes: a configuration unit configured to configure the number of the plurality of subcarriers to be used for transmission to the specific number of the plurality of subcarriers less than or equal to the prescribed number of the plurality of subcarriers; and a transmitter configured to transmit, in a prescribed communication band, a transmit signal by using the plurality of subcarriers of the specific number among the plurality of subcarriers of the prescribed number, in which the transmit signal does not include information for indicating the specific number of the plurality of subcarriers, the transmitter performs determination of a frequency in the prescribed communication band to which the plurality of subcarriers of the specific number are allocated, and the determination of the frequency in the prescribed communication band is not configured by the base station apparatus.

### TECHNICAL FIELD

An aspect of the present invention relates to a terminal apparatus, a base station apparatus, a communication method, and an integrated circuit.

This application claims priority based on JP 2017-050611 filed on Mar. 15, 2017, the contents of which are incorporated herein by reference.

### BACKGROUND ART

In recent years, 5th Generation mobile telecommunication systems (5G) are garnering attention. In 5G, specifications for a communication technology that mainly achieves MTC (Massive Machine Type Communications (mMTC)) by multiple terminal apparatuses, Ultra-reliable and low latency communications (URLLC), and higher-capacity and higher-speed communication (enhanced Mobile BroadBand (eMBB)) are anticipated to be created. In the 3rd Generation Partnership Project (3GPP), New Radio (NR) has been studied as a communication technology for 5G, and an NR Multiple Access (MA) has been discussed.

5G is expected to achieve Internet of Things (IoT) to connect various apparatuses, which have not previously been connected to a network, to the network, and the mMTC implementation is one of important elements. In the 3GPP, a Machine-to-Machine (M2M) communication technology has already been standardized as the Machine Type Communication (MTC) for accommodating a terminal apparatus configured to transmit and/or receive small size data (NPL 1). Furthermore, in order to support data transmission at a low rate in a narrow band, the 3GPP is also in the process of creating specification for Narrow Band-IoT (NB-IoT) (NPL 2). 5G is expected to achieve accommodation of more terminals than these standard specifications, and to accommodate IoT apparatuses requiring an ultra-reliable and low latency communication.

On the other hand, in a communication system such as Long Term Evolution (LTE), LTE-Advanced (LTE-A), and the like, which are specified in the 3GPP, the terminal apparatus (User Equipment (UE)) requests, using a Random Access Procedure, a Scheduling Request (SR), and the like, a radio resource for transmitting uplink data, to a Base Station Apparatus (BS, also referred to as evolved Node B (eNB)). The base station apparatus provides an uplink transmission grant (UL Grant) to each terminal apparatus based on the SR. In a case of receiving the UL Grant as control information from the base station apparatus, the terminal apparatus transmits the uplink data with a prescribed radio resource based on an uplink transmission parameter included in the UL Grant (also referred to as Scheduled access or grant-based access. Hereinafter, referred to as scheduled access).

In this manner, the base station apparatus controls transmission of all uplink data (the base station apparatus is configured to grasp the radio resource of the uplink data transmitted by each terminal apparatus). In the scheduled access, Orthogonal Multiple Access (OMA) can be achieved by the base station apparatus controlling the uplink radio resource.

In the mMTC of 5G, in a case of using the scheduled access, an increase in the amount of control information is problematic. Additionally, in the URLLC, in a case of using the scheduled access, an increase in the latency is problematic. Accordingly, in the 3GPP, grant free access (also referred to as grant less access, Contention-based access, Autonomous access, or the like. Hereinafter, referred to as grant free access), in which the terminal apparatus performs data transmission without transmitting the random access procedure and the SR and without performing the UL Grant reception and the like, has been studied (NPL 3).

In the grant free access, the increase in overhead due to the control information can be suppressed even in a case that multiple devices transmit small size data. Furthermore, in the grant free access, since the UL Grant reception and the like are not performed, time from transmission data generation to transmission can also be shortened.

In addition, variable rate transmission in which the terminal apparatus flexibly changes a transmission rate in accordance with a traffic amount, a radio propagation environment, and a capability of the terminal apparatus itself is effective for improving frequency efficiency, and the variable rate transmission is expected to be achieved in the grant free access as well.

### CITATION LIST

### Non Patent Literature

NPL 1: 3GPP, TR36.888 V12.0.0, “Study on provision of low-cost Machine-Type Communications (MTC) User Equipments (UEs) based on LTE,” Jun. 26, 2013, http://portal.3gpp.org/desktopmodules/Specifications/SpecificationDetails.aspx?specificationId=2578, [Search Date: Feb. 13, 2017]
NPL 2: 3GPP, TR45.820 V13.0.0, “Cellular system support for ultra-low complexity and low throughput Internet of Things (CIoT),” Sep. 22, 2015, http://portal.3gpp.org/desktopmodules/Specifications/SpecificationDetails.aspx?specificationId=2719, [Search Date: Feb. 13, 2017]
NPL 3: ZTE, ZTE Microwmwctronics, InterDigital, Qualcomm Inc., Spraedtrum, “WF on Scenarios for Multiple Access”, R1-165595, 3GPP TSG RAN WG1 #85 Meeting, Nanjing, China, May 30, 2016, http://portal.3gpp.org/ngppapp/CreateTdoc.aspx?mode=view&contributionId=712070, [Search Date: Feb. 13, 2017]

### SUMMARY OF INVENTION

### Technical Problem

However, in the grant free access that has been discussed in the related art, the terminal apparatus is capable of transmitting uplink data with low latency, whereas the number of subcarriers is fixed, and thus there is a problem in that a limitation occurs in performing the variable rate transmission.

An aspect of the present invention has been made in light of the foregoing circumstances, and an object of the present invention is to provide a terminal apparatus, a base station apparatus, a communication method, and an integrated circuit, capable of achieving flexible variable rate transmission with grant free access.

### Solution to Problem

A first aspect of the present invention has been made to solve the above-described problems, and is a terminal apparatus for communicating with a base station apparatus by using a plurality of subcarriers by a grant free access scheme, the terminal apparatus includes: a configuration unit configured to configure the number of the plurality of subcarriers to be used for transmission to the specific number of the plurality of subcarriers less than or equal to the prescribed number of the plurality of subcarriers; and a transmitter configured to transmit, in a prescribed communication band, a transmit signal by using the plurality of subcarriers of the specific number among the plurality of subcarriers of the prescribed number, in which the transmit signal does not include information for indicating the specific number of subcarriers, the transmitter performs determination of a frequency in the prescribed communication band to which the plurality of subcarriers of the specific number are allocated, and the determination of the frequency in the prescribed communication band is not configured by the base station apparatus.

Furthermore, a second aspect of the present invention is the terminal apparatus described above, in which the prescribed number may be obtained from the base station apparatus.

Furthermore, a third aspect of the present invention is the terminal apparatus described above, in which the configuration unit may configure transmission efficiency of the transmit signal based on the specific number of the plurality of subcarriers.

Furthermore, a fourth aspect of the present invention is the terminal apparatus described above, in which the configuration unit may configure the specific number of the plurality of subcarriers based on transmit power of the transmit signal.

Furthermore, a fifth aspect of the present invention is the terminal apparatus described above, in which a candidate of the frequency in the prescribed communication band may be configured by the base station apparatus.

Furthermore, a sixth aspect of the present invention is the terminal apparatus described above, in which the specific number of the plurality of subcarriers may include the first number of the plurality of subcarriers and the second number of the plurality of subcarriers greater than the first number of the plurality of subcarriers, and the candidate of the frequency in the prescribed frequency band to which the configuration unit allocates the plurality of subcarriers of the first number may be a subset of the candidate of the frequency in the prescribed frequency band to which the plurality of subcarriers of the second number are allocated.

Furthermore, a seventh aspect of the present invention is the terminal apparatus described above, the terminal apparatus may further include: a receiver configured to receive a signal including control information for indicating that any of at least two transmission modes is configured, the ate least two transmission modes including a first transmission mode that allows the specific number of the plurality of subcarriers to be configured and a second transmission mode in which the specific number of the plurality of subcarriers is preconfigured, in which the configuration unit may configure, in a case that the first transmission mode is configured, the specific number of the plurality of subcarriers to a selected value, and may configure, in a case that the second transmission mode is configured, the specific number of the plurality of subcarriers to a value configured by the base station apparatus.

Furthermore, an eighth aspect of the present invention has been made to solve the above-described problems, and is a base station apparatus for communicating with a terminal apparatus by using a plurality of subcarriers by a grant free access scheme, the base station apparatus includes: a receiver configured to receive a signal transmitted from the terminal apparatus; and a signal demodulation unit configured to obtain the number of the plurality of subcarriers based on the signal.

Furthermore, a ninth aspect of the present invention is the base station apparatus described above, in which the signal demodulation unit may obtain transmission efficiency configured to the signal based on the number of the plurality of subcarriers.

Furthermore, a tenth aspect of the present invention is the base station apparatus described above, the base station apparatus may further include: a transmitter configured to transmit a signal including information for indicating a candidate of the number of the plurality of subcarriers configurable by the terminal apparatus, to the terminal apparatus.

Furthermore, an eleventh aspect of the present invention is the base station apparatus described above, in which the transmitter may transmit a signal including control information for indicating that any of at least two transmission modes is configured, the at least two transmission modes including a first transmission mode that allows the number of the plurality of subcarriers to be configured and a second transmission mode in which the number of the plurality of subcarriers is preconfigured.

Furthermore, a twelfth aspect of the present invention is the base station apparatus described above, in which the signal demodulation unit may obtain the number of the plurality of subcarriers by using compressed sensing.

Furthermore, a thirteenth aspect of the present invention is the base station apparatus described above, in which the signal demodulation unit may obtain the number of the plurality of subcarriers by using reception power determination using a prescribed threshold.

Furthermore, a fourteenth aspect of the present invention has been made to solve the above-described problems, and is a communication method used by a terminal apparatus for communicating with a base station apparatus by using a plurality of subcarriers by a grant free access scheme, the communication method includes the steps of: configuring the number of the plurality of subcarriers to be used for transmission to the specific number of the plurality of subcarriers less than or equal to the prescribed number of the plurality of subcarriers; and transmitting a transmit signal, in a prescribed communication band, by using the plurality of subcarriers of the specific number among the plurality of subcarriers of the prescribed number, in which the transmit signal does not include information for indicating the specific number of the plurality of subcarriers, in the transmitting, determination of a frequency in the prescribed communication band to which the plurality of subcarriers of the specific number are allocated is performed, and the determination of the frequency in the prescribed communication band is not configured by the base station apparatus.

Furthermore, a fifteenth aspect of the present invention has been made to solve the above-described problems, and is a communication method used by a base station apparatus for communicating with a terminal apparatus by using a plurality of subcarriers by a grant free access scheme, the communication method includes the steps of: receiving a signal transmitted from the terminal apparatus; and signal-demodulating for obtaining the number of the plurality of subcarriers based on the signal.

Furthermore, a sixteenth aspect of the present invention has been made to solve the above-described problems, and is an integrated circuit mounted in a terminal apparatus for communicating with a base station apparatus by using a plurality of subcarriers by a grant free access scheme, the integrated circuit being configured to perform the steps of: configuring the number of the plurality of subcarriers to be used for transmission to the specific number of the plurality of subcarriers less than or equal to the prescribed number of the plurality of subcarriers; and transmitting a transmit signal, in a prescribed communication band, by using the plurality of subcarriers of the specific number among the plurality of subcarriers of the prescribed number, in which the transmit signal does not include information for indicating the specific number of the plurality of subcarriers, in the transmitting, determination of a frequency in the prescribed communication band to which the plurality of subcarriers of the specific number are allocated is performed, and the determination of the frequency in the prescribed communication band is not configured by the base station apparatus.

Furthermore, a seventeenth aspect of the present invention has been made to solve the above-described problems, and is an integrated circuit mounted in a base station apparatus for communicating with a terminal apparatus by using a plurality of subcarriers by a grant free access scheme, the integrated circuit being configured to perform the steps of: receiving a signal transmitted from the terminal apparatus; and signal-demodulating for obtaining the number of the plurality of subcarriers based on the signal.

### Advantageous Effects of Invention

According to an aspect of the present invention, a terminal apparatus, a base station apparatus, a communication method, and an integrated circuit, capable of achieving flexible variable rate transmission with grant free access, can be provided.

### BRIEF DESCRIPTION OF DRAWINGS

FIG. 1 is a schematic diagram illustrating an example of a configuration of a radio communication system according to a first embodiment of the present invention.

FIG. 2 is a schematic block diagram illustrating an example of a configuration of a terminal apparatus according to the first embodiment of the present invention.

FIG. 3 is a schematic block diagram illustrating an example of a configuration of a control unit of the terminal apparatus according to the first embodiment of the present invention.

FIG. 4 is a schematic block diagram illustrating an example of a configuration of a base station apparatus according to the first embodiment of the present invention.

FIGS. 5A to 5E are descriptive diagrams illustrating an example of the number of subcarriers and a subcarrier subset according to the first embodiment of the present invention.

FIG. 6 is a flowchart illustrating an example of a communication method according to the first embodiment of the present invention.

FIG. 7 is a schematic block diagram illustrating an example of a configuration of a control unit of a terminal apparatus according to a second embodiment of the present invention.

FIG. 8 is a flowchart illustrating an example of a communication method according to the second embodiment of the present invention.

FIG. 9 is a schematic block diagram illustrating an example of a configuration of a control unit of a terminal apparatus according to a third embodiment of the present invention.

FIG. 10 is a flowchart illustrating an example of a communication method according to the third embodiment of the present invention.

### DESCRIPTION OF EMBODIMENTS

Hereinafter, embodiments of the present invention are described in detail with reference to the drawings.

### First Embodiment

FIG. 1 is a schematic diagram illustrating an example of a configuration of a radio communication system according to a first embodiment of the present invention.

In FIG. 1, a radio communication system Sys is configured to include a terminal apparatus 1 and a base station apparatus 3. The base station apparatus 3 may include a plurality of other base station apparatuses (not illustrated). Note that the base station apparatus 3 may include an MME/GW. At this time, the base station apparatus 3 is connected to the MME/GW through a backhaul link S (also referred to as an S1 link). The base station apparatuses are mutually connected through a backhaul link X2 (also referred to as an X2 link).

The terminal apparatus 1 communicates with the base station apparatus 3 using an uplink to the base station apparatus 3 and a downlink from the base station apparatus 3 to the terminal apparatus 1.

The base station apparatus 3 forms (manages) a plurality of cells and communicates with the terminal apparatus 1.

Here, physical channels and physical signals according to the present embodiment will be described.

The following physical channels may be used for radio communication between the terminal apparatus 1 and the base station apparatus 3.
Physical Control CHannel (PCCH)
Physical Shared CHannel (PSCH)

The PCCH and the PSCH may include both the downlink and the uplink, and may indicate whether downlink control information and/or each subframe of a higher layer and/or a resource unit is the downlink or the uplink. Hereinafter, description will be given assuming that a channel of each of the uplink and the downlink is defined.

In uplink radio communication from the terminal apparatus 1 to the base station apparatus 3, the following uplink physical channels are used. The uplink physical channels are used by a physical layer for transmission of information output from a higher layer.
Physical Uplink Control CHannel (PUCCH)
Physical Uplink Shared CHannel (PUSCH)
Physical Random Access CHannel (PRACH)

The physical uplink control channel (PUCCH) is a channel that is used to transmit Uplink Control Information (UCI). The uplink control information includes a Scheduling Request (SR) to be used to request a PUSCH (UpLink-Shared CHannel (UL-SCH)) resource for downlink Channel State Information (CSI) initial transmission, and HARQ control information (Hybrid Automatic Repeat request ACKnowledgement (HARQ-ACK)) for downlink data (a Transport block (TB), a Medium Access control Protocol Data Unit (MAC PDU), a DownLink-Shared CHannel (DL-SCH), or a Physical Downlink Shared CHannel (PDSCH)). The HARQ-ACK represents an acknowledgement (ACK) and/or a negative-acknowledgement (NACK). Here, the ACK indicates that reception of the DL-SCH/PDSCH is successful in the terminal apparatus 1, and the NACK indicates that the reception of the DL-SCH/PDSCH has failed in the terminal apparatus 1.

The CSI includes a Channel Quality Indicator (CQI), a Precoding Matrix Indicator (PMI), a Precoding Type Indicator (PTI), and a Rank Indicator (RI). Indication may be used as a notation for each indicator.

The physical uplink shared channel (PUSCH) is used for transmission of uplink data (UpLink-Shared CHannel (UL-SCH)). Furthermore, the PUSCH is used to transmit (perform notification of) various higher layer parameters and various configuration information and measurement information (e.g., a measurement report) relating to the terminal apparatus 1 as a random access message 3, a layer 2 message, and a layer 3 message. Furthermore, the PUSCH is also used to transmit (perform notification of) the uplink control information. Furthermore, the PUSCH may be used to transmit the HARQ-ACK and/or the channel state information along with the uplink data not including the random access message 3. Furthermore, the PUSCH may be used to transmit only the channel state information or to transmit only the HARQ-ACK and the channel state information. Furthermore, radio resource allocation information of the physical uplink shared channel is indicated by a physical downlink control channel.

The PRACH is used to transmit a random access preamble (random access message 1). The PRACH may be used for indicating an initial connection establishment procedure, a handover procedure, a connection re-establishment procedure, synchronization (timing adjustment) for uplink transmission, and/or a request for a PUSCH (UL-SCH) resource.

The following downlink physical channels are used for downlink radio communication from the base station apparatus 3 to the terminal apparatus 1. The downlink physical channels are used by the physical layer for transmission of information output from the higher layer.
Physical Broadcast CHannel (PBCH)
Physical Control Format Indicator CHannel (PCFICH)
Physical Hybrid automatic repeat request Indicator CHannel (PHICH)
Physical Downlink Control CHannel (PDCCH)
Enhanced Physical Downlink Control CHannel (EPDCCH)
Physical Downlink Shared CHannel (PDSCH)
Physical Multicast CHannel (PMCH)

The physical broadcast channel (PBCH) is used for broadcasting a Master Information Block (MIB, a Broadcast CHannel (BCH), Essential System Information) that is shared by the terminal apparatuses 1.

The physical control format indicator channel (PCFICH) is used for transmission of information indicating a region (OFDM symbols) to be used for transmission of the PDCCH.

The physical HARQ indicator channel (PHICH) is used for transmission of an HARQ indicator (HARQ feedback, response information, HARQ control information) indicating an ACKnowledgement (ACK) and/or a Negative ACKnowledgement (NACK) for the uplink data (UpLink Shared CHannel (UL-SCH)) received by the base station apparatus 3.

The physical downlink control channel (PDCCH) and/or the enhanced physical downlink control channel (EPDCCH) is used to transmit Downlink Control Information (DCI). The downlink control information is also referred to as DCI format. The downlink control information includes a downlink grant and/or an uplink grant. The downlink grant is also referred to as a downlink assignment and/or a downlink allocation.

One downlink grant is used for scheduling of one PDSCH within one serving cell. The downlink grant is used for the scheduling of the PDSCH within the same subframe as the subframe on which the downlink grant is transmitted.

One uplink grant is used for scheduling of one PUSCH within one serving cell. The uplink grant is used for scheduling of the PUSCH within the fourth or later subframe from the subframe in which the uplink grant is transmitted.

The uplink grant transmitted on the PDCCH includes a DCI format 0. A transmission scheme of the PUSCH corresponding to the DCI format 0 is a single antenna port. The terminal apparatus 1 uses a single antenna port transmission scheme for the PUSCH transmission corresponding to the DCI format 0. The PUSCH to which the single antenna port transmission scheme is applied is used for transmission of one codeword (one transport block).

The uplink grant transmitted on the PDCCH includes a DCI format 4. A transmission scheme of the PUSCH corresponding to the DCI format 4 is closed-loop spatial multiplexing. The terminal apparatus 1 uses a closed-loop spatial multiplexing transmission scheme for the PUSCH transmission corresponding to the DCI format 4. The PUSCH to which the closed-loop spatial multiplexing transmission scheme is applied is used for transmission of up to two codewords (up to two transport blocks).

Cyclic Redundancy Check (CRC) parity bits added to the downlink grant and/or the uplink grant are scrambled with a Cell-Radio Network Temporary Identifier (C-RNTI), Temporary C-RNTI, or a Semi Persistent Scheduling (SPS) C-RNTI. The C-RNTI and/or the SPS C-RNTI is an identifier for identifying a terminal apparatus within a cell. The Temporary C-RNTI is used during a contention based random access procedure.

The C-RNTI (an identifier (identification information) of the terminal apparatus) is used to control the PDSCH and/or the PUSCH in one subframe. The SPS C-RNTI is used to periodically allocate a resource for the PDSCH and/or the PUSCH. The Temporary C-RNTI is used to schedule re-transmission of the random access message 3 and/or transmission of a random access message 4.

The physical downlink shared channel (PDSCH) is used to transmit downlink data (Downlink Shared CHannel (DL-SCH)). The PDSCH is used to transmit a random access message 2 (random access response). The PDSCH is used to transmit a handover command.

The random access response includes a random access response grant. The random access response grant is an uplink grant transmitted on the PDSCH. The terminal apparatus 1 uses the single antenna port transmission scheme for the PUSCH transmission corresponding to the random access response grant and/or the PUSCH re-transmission for the same transport block.

The PMCH is used to transmit multicast data (Multicast CHannel (MCH)).

The following downlink physical signals are used in the downlink radio communication. The downlink physical signals are not used for transmission of information output from the higher layer, but are used by the physical layer.
Synchronization signal (SS)
Downlink Reference Signal (DL RS)

The synchronization signal is used for the terminal apparatus 1 to take synchronization in a frequency domain and/or a time domain in the downlink.

The downlink reference signal is used for the terminal apparatus 1 to perform channel compensation on a downlink physical channel. The downlink reference signal is used in order for the terminal apparatus 1 to obtain the downlink channel state information.

According to the present embodiment, the following seven types of downlink reference signals are used.
Cell-specific Reference Signal (CRS)
UE-specific Reference Signal (UERS) relating to the PDSCH
Demodulation Reference Signal (DMRS) relating to the EPDCCH
Non-Zero Power Channel State Information-Reference Signal (NZP CSI-RS)
Zero Power Channel State Information-Reference Signal (ZP CSI-RS)
Multimedia Broadcast and Multicast Service over Single Frequency Network Reference signal (MBSFN RS)
Positioning Reference Signal (PRS)

The downlink physical channels and/or the downlink physical signals are collectively referred to as a downlink signal. The uplink physical channels and/or the uplink physical signals are collectively referred to as an uplink signal. The downlink physical channels and/or the uplink physical channels are collectively referred to as a physical channel. The downlink physical signals and/or the uplink physical signals are collectively referred to as a physical signal.

The BCH, the MCH, the UL-SCH, and the DL-SCH are transport channels. A channel used in a Medium Access Control (MAC) layer is referred to as a transport channel. A unit of the transport channel used in the MAC layer is also referred to as a transport block (TB) and/or a MAC Protocol Data Unit (PDU). A Hybrid Automatic Repeat reQuest (HARQ) is controlled for each transport block in the MAC layer. The transport block is a unit of data that the MAC layer delivers to the physical layer. In the physical layer, the transport block is mapped to a codeword, and coding processing is performed for each codeword.

As described above, the physical channel corresponds to a set of resource elements transmitting information output from the higher layer. The physical signal is used in the physical layer and does not transmit information output from the higher layer. In other words, higher layer control information such as a Radio Resource Control (RRC) message and System Information (SI) is transmitted on the physical channel.

Additionally, as described above, the downlink physical channel includes the physical downlink shared channel (PDSCH), the physical broadcast channel (PBCH), a physical multicast channel (PMCH), the physical control format indicator channel (PCFICH), the physical downlink control channel (PDCCH), the physical hybrid ARQ indicator channel (PHICH), and the enhanced physical downlink control channel (EPDCCH). Note that the physical downlink shared channel (PDSCH) and the physical uplink control channel (PUCCH) may be transmitted as a Physical Shared CHannel (PSCH).

Additionally, as described above, the downlink physical signal includes various reference signals and various synchronization signals. The downlink reference signal includes a cell-specific reference signal (CRS), a terminal apparatus-specific reference signal (UERS), and a channel state information reference signal (CSI-RS). The synchronization signal includes a Primary Synchronization Signal (PSS) and a Secondary Synchronization Signal (SSS).

Next, configurations of the terminal apparatus 1 and the base station apparatus 3 in the first embodiment of the present invention will be described.

FIG. 2 is a schematic block diagram illustrating an example of a configuration of the terminal apparatus 1 according to the first embodiment of the present invention.

The terminal apparatus 1 is configured to include a processing unit 101, a control unit 103A, a receiver 105, a transmitter 107, and a transmit and/or receive antenna unit 109. The processing unit 101 is configured to include a radio resource control unit 1011 and a scheduling information interpretation unit 1013. The receiver 105 is configured to include a decoding unit 1051, a demodulation unit 1053, a demultiplexing unit 1055, a radio receiving unit 1057, and a channel measurement unit 1059. The transmitter 107 is configured to include a coding unit 1071, a modulating unit 1073, a multiplexing unit 1075, a radio transmitting unit 1077, and an uplink reference signal generation unit 1079.

Note that each of the functional units of the terminal apparatus 1 may be configured so as to be capable of being achieved by one or a plurality of integrated circuits, or may be achieved by software.

The processing unit 101 outputs uplink data (transport block) generated by a user operation or the like, to the transmitter 107. The processing unit 101 performs processing of Medium Access Control (MAC), a Packet Data Convergence Protocol (PDCP) layer, a Radio Link Control (RLC) layer, a Radio Resource Control (RRC) layer, and the like.

The radio resource control unit 1011 included in the processing unit 101 manages various configuration information/parameters of the terminal apparatus 1 itself. The radio resource control unit 1011 sets the various configuration information/parameters in accordance with higher layer signaling received from the base station apparatus 3. To be more specific, the radio resource control unit 1011 sets the various configuration information/parameters in accordance with the information indicating the various configuration information/parameters received from the base station apparatus 3. Furthermore, the radio resource control unit 1011 generates information to be mapped to each uplink channel, and outputs the generated information to the transmitter 107. The radio resource control unit 1011 is also referred to as a configuration unit 1011.

Here, the scheduling information interpretation unit 1013 included in the processing unit 101 interprets (analyzes) a DCI format (scheduling information, UL grant) received through the receiver 105, generates control information for control of the receiver 105 and the transmitter 107, in accordance with a result of interpreting the DCI format (analysis result), and outputs the generated control information to the control unit 103A.

In accordance with the control information originating from the processing unit 101, the control unit 103A generates a control signal for control of the receiver 105 and the transmitter 107. The control unit 103A outputs the generated control signal to the receiver 105 and the transmitter 107 to control the receiver 105 and the transmitter 107.

The control unit 103A determines the number of subcarriers to be used for transmission, and determines the frequency to be used in a communication band. Details will be described later.

In accordance with the control signal input from the control unit 103A, the receiver 105 demultiplexes, demodulates, and decodes a reception signal received from the base station apparatus 3 through the transmit and/or receive antenna unit 109, and outputs the information resulting from the decoding, to the processing unit 101.

The radio receiving unit 1057 converts (Down-Converts) a downlink signal received through the transmit and/or receive antenna unit 109 into a baseband signal through orthogonal demodulation, removes unnecessary frequency components, controls an amplification level in such a manner as to suitably maintain a signal level, performs orthogonal demodulation, based on an in-phase component and an orthogonal component of the received signal, and converts the resulting orthogonally-demodulated analog signal into a digital signal. The radio receiving unit 1057 removes a portion corresponding to a Cyclic Prefix (CP) from the digital signal resulting from the conversion, performs Fast Fourier Transform (FFT) on the signal from which the CP has been removed, and extracts a signal in the frequency domain.

The demultiplexing unit 1055 demultiplexes the extracted signal into the PHICH, the PDCCH, the PDSCH, and the downlink reference signal. Moreover, the demultiplexing unit 1055 makes a compensation of channels including the PHICH, the PDCCH, and the PDSCH, from a channel estimate input from the channel measurement unit 1059. Furthermore, the demultiplexing unit 1055 outputs the downlink reference signal resulting from the demultiplexing, to the channel measurement unit 1059.

The demodulation unit 1053 multiplies the PHICH by a corresponding code for composition, demodulates the resulting composite signal in compliance with a Binary Phase Shift Keying (BPSK) modulation scheme, and outputs a result of the demodulation to the decoding unit 1051. The decoding unit 1051 decodes the PHICH destined for the terminal apparatus 1 itself and outputs the HARQ indicator resulting from the decoding to the processing unit 101. The demodulation unit 1053 demodulates the PDCCH in compliance with a QPSK modulation scheme and outputs a result of the demodulation to the decoding unit 1051. The decoding unit 1051 attempts to decode the PDCCH and outputs, in a case of succeeding in the decoding, downlink control information resulting from the decoding and an RNTI to which the downlink control information corresponds, to the processing unit 101.

The demodulation unit 1053 demodulates the PDSCH in compliance with a modulation scheme notified with the downlink grant, such as Quadrature Phase Shift Keying (QPSK), 16 Quadrature Amplitude Modulation (QAM), or 64 QAM, and outputs a result of the demodulation to the decoding unit 1051. The decoding unit 1051 decodes the data in accordance with information of a coding rate notified with the downlink control information, and outputs, to the processing unit 101, the downlink data (the transport block) resulting from the decoding.

The channel measurement unit 1059 measures a downlink path loss or a channel state from the downlink reference signal input from the demultiplexing unit 1055, and outputs the measured path loss or channel state to the processing unit 101. Furthermore, the channel measurement unit 1059 calculates a downlink channel estimate from the downlink reference signal and outputs the calculated downlink channel estimate to the demultiplexing unit 1055. The channel measurement unit 1059 performs channel measurement and/or/and/or interference measurement in order to calculate the CQI (or the CSI).

The transmitter 107 generates the uplink reference signal in accordance with the control signal input from the control unit 103A, codes and/or modulates the uplink data (the transport block) input from the processing unit 101, multiplexes the PUCCH, the PUSCH, and/or the generated uplink reference signal, and transmits a result of the multiplexing to the base station apparatus 3 through the transmit and/or receive antenna unit 109. Furthermore, the transmitter 107 transmits uplink control information.

The coding unit 1071 performs coding, such as convolutional coding or block coding, on the uplink control information input from the processing unit 101. Furthermore, the coding unit 1071 performs turbo coding in accordance with information used for the scheduling of the PUSCH.

The modulating unit 1073 modulates coded bits input from the coding unit 1071, in compliance with a modulation scheme predetermined for each number of subcarriers and/or a modulation scheme predetermined regardless of the number of subcarriers and/or a modulation scheme notified with the downlink control information and/or a modulation scheme predetermined for each channel, such as BPSK, QPSK, 16 QAM, or 64 QAM. In accordance with the information used for the scheduling of the PUSCH, the modulating unit 1073 determines the number of data sequences to be spatial-multiplexed, maps multiple pieces of uplink data to be transmitted on the same PUSCH to multiple sequences through Multiple Input Multiple Output (MIMO) and Spatial Multiplexing (SM), and performs precoding on the sequences.

The uplink reference signal generation unit 1079 generates a sequence acquired in accordance with a rule (formula) predetermined in advance, based on a physical layer cell identifier (also referred to as a Physical layer cell identity (PCI), a Cell ID, or the like) for identifying the base station apparatus 3, a bandwidth to which the uplink reference signal is mapped, a cyclic shift notified with the uplink grant, a parameter value for generation of a DMRS sequence, and the like. In accordance with the control signal input from the control unit 103A, the multiplexing unit 1075 rearranges modulation symbols of the PUSCH in parallel and then performs Discrete Fourier Transform (DFT) on the rearranged modulation symbols. Furthermore, the multiplexing unit 1075 multiplexes PUCCH and PUSCH signals and the generated uplink reference signal for each transmit antenna port. To be more specific, the multiplexing unit 1075 maps the PUCCH and PUSCH signals and the generated uplink reference signal to the resource elements for each transmit antenna port.

The radio transmitting unit 1077 performs Inverse Fast Fourier Transform (IFFT) on a signal resulting from the multiplexing, generates an SC-FDMA symbol, adds a CP to the generated SC-FDMA symbol, generates a baseband digital signal, converts the baseband digital signal into an analog signal, removes unnecessary frequency components through a lowpass filter, up-converts a result of the removal into a signal of a carrier frequency, performs power amplification, and outputs a final result to the transmit and/or receive antenna unit 109 for transmission.

FIG. 3 is a schematic block diagram illustrating an example of a configuration of the control unit 103A of the terminal apparatus 1 according to the first embodiment of the present invention.

The control unit 103A is configured to include a configuration unit 1031 and a transmission control unit 1033. The configuration unit 1031 is configured to include a subcarrier number configuration unit 10311 and a transmission efficiency configuration unit 10313. The transmission control unit 1033 is configured to include a frequency determination unit 10331.

As described above, in accordance with the control information originating from the processing unit 101, the control unit 103A generates a control signal for control of the receiver 105 and the transmitter 107. The control unit 103A outputs the generated control signal to the receiver 105 and the transmitter 107 to control the receiver 105 and the transmitter 107. The other processing of the control unit 103A will be described in detail below.

Based on information on the prescribed number of subcarriers included in the control information from the processing unit 101, the subcarrier number configuration unit 10311 determines the number of subcarriers to be used for the terminal apparatus 1 to communicate with the base station apparatus 3 (also referred to as the specific number of subcarriers). The information on the prescribed number of subcarriers is information indicating the prescribed number of subcarriers that the terminal apparatus 1 can use (select or determine) for communication. For example, the prescribed number of subcarriers is the maximum number of subcarriers (maximum number). Note that the prescribed number of subcarriers need not be the maximum number of subcarriers, and the arbitrary number of subcarriers may be reported as the prescribed number from the base station apparatus 3 via the processing unit 101.

The subcarrier number configuration unit 10311 selects (determines), based on transmit power of the terminal apparatus 1, the number of subcarriers being less than or equal to the prescribed number of subcarriers as the specific number of subcarriers to be used for communication with the base station apparatus 3. The subcarrier number configuration unit 10311 outputs a signal representing the determined specific number of subcarriers to the transmission efficiency configuration unit 10313.

The subcarrier number configuration unit 10311 may configure the specific number of subcarriers and a frequency to which the subcarrier is allocated based on the channel state information, grasped by the terminal apparatus 1, between the terminal apparatus and the base station apparatus 3. For example, the subcarrier number configuration unit 10311 can improve reception quality by allocating the subcarrier to a frequency having a good channel state in a communication band to which the subcarrier can be allocated.

Note that the subcarrier number configuration unit 10311 may determine the number of subcarriers being less than or equal to the prescribed number of subcarriers as the specific number of subcarriers, without using the information on the prescribed number of subcarriers from the base station apparatus 3. In this case, it is sufficient that the prescribed number of subcarriers is determined beforehand.

Note that the subcarrier number configuration unit 10311 may configure the number of subcarriers being less than or equal to the prescribed number of subcarriers at the time of re-transmission to the number greater or less than the specific number of subcarriers at the time of initial transmission. The subcarrier number configuration unit 10311 configures the specific number of subcarriers at the time of re-transmission to the number less than the specific number of subcarriers at the time of initial transmission (or less than or equal to the specific number of subcarriers at the time of initial transmission), so that the impinging probability on a bucket transmitted by another terminal apparatus can be reduced. On the other hand, the subcarrier number configuration unit 10311 configures the specific number of subcarriers at the time of re-transmitting to the number greater (more) than the specific number of subcarriers at the time of initial transmission (or greater than or equal to the specific number of subcarriers at the time of initial transmission), so that a frequency diversity effect is obtained for a re-transmission packet, and by a capture effect, even in a case that the packet transmitted by the other terminal apparatus impinges on the re-transmission packet, the base station apparatus 3 can correctly demodulate the re-transmission packet. In addition, the subcarrier number configuration unit 10311 can configure the specific number of subcarriers of the re-transmission packet in accordance with a propagation environment and the like. In addition, the subcarrier number configuration unit 10311 can cause the base station apparatus 3 to configure the specific number of subcarriers of the re-transmission packet.

At this time, the subcarrier number configuration unit 10311 may configure the transmit power at the time of re-transmission to be higher than the transmit power at the time of initial transmission, or to be proportional (inversely proportional) to the number of subcarriers.

The transmission efficiency configuration unit 10313 configures transmission efficiency for the transmit signal from the terminal apparatus 1 to the base station apparatus 3 based on the signal representing the specific number of subcarriers from the subcarrier number configuration unit 10311.

The transmission control unit 1033 controls the transmitter 107. Specifically, in a case that the configuration of the transmission efficiency by the subcarrier number configuration unit 10311 is completed, the frequency determination unit 10331 determines the frequency to be used for communication in the communication band used by the terminal apparatus 1 and the base station apparatus 3 for communication. The frequency determination unit 10331 allocates the transmit signal to the subcarriers of the specific number of subcarriers of the determined frequency in the communication band. Then, the transmission control unit 1033 transmits, via the transmitter 107, using the subcarriers of the specific number of subcarriers to which the transmit signal is allocated, the transmit signal to the base station apparatus 3.

Note that the frequency determination unit 10331 may determine the frequency in the communication band to which the subcarriers of the specific number of subcarriers are allocated at the time of re-transmission, to a frequency which is different from some or all of the frequencies in the communication band at the time of initial transmission, allocate the subcarriers of the specific number of subcarriers to the determined frequency, and perform transmission. Furthermore, the transmission control unit 1033 may be included in the transmitter 107 instead of the control unit 103A.

FIG. 4 is a schematic block diagram illustrating an example of a configuration of the base station apparatus 3 according to the first embodiment of the present invention.

The base station apparatus 3 is configured to include a processing unit 301, a control unit 303, a receiver 305, a transmitter 307, and a transmit and/or receive antenna unit 309. The processing unit 301 is configured to include a radio resource control unit 3011 and a scheduling unit 3013. The receiver 305 is configured to include a decoding unit 3051, a demodulation unit 3053, a demultiplexing unit 3055, a radio receiving unit 3057, and a channel measurement unit 3059. The transmitter 307 is configured to include a coding unit 3071, a modulating unit 3073, a multiplexing unit 3075, a radio transmitting unit 3077, and a downlink reference signal generation unit 3079.

Note that each of the functional units of the base station apparatus 3 may be configured so as to be capable of being achieved by one or a plurality of integrated circuits, or may be achieved by software.

The processing unit 301 performs processing of a Medium Access Control (MAC) layer, a Packet Data Convergence Protocol (PDCP) layer, a Radio Link Control (RLC) layer, and a Radio Resource Control (RRC) layer. Furthermore, the processing unit 301 generates control information for control of the receiver 305 and the transmitter 307, and outputs the generated control information to the control unit 303.

The radio resource control unit 3011 included in the processing unit 301 generates, or acquires from a higher node, the downlink data (the transport block) mapped to the downlink PDSCH, system information, the RRC message, the MAC Control Element (CE), and the like, and outputs a result of the generation or the acquirement to the transmitter 307. Furthermore, the radio resource control unit 3011 manages various configuration information/parameters for each of the terminal apparatuses 1. The radio resource control unit 3011 may configure various configuration information/parameters for each of the terminal apparatuses 1 through higher layer signaling. In other words, the radio resource control unit 1011 transmits/broadcasts information indicating various configuration information/parameters. The radio resource control unit 3011 is also referred to as a configuration unit 3011.

Note that the scheduling unit 3013 included in the processing unit 301 may determine a frequency (a frequency indicating a selection range for determining the frequency by the terminal apparatus 1, or a frequency to be a candidate for determining the frequency by the terminal apparatus 1) and/or a subframe to which the physical channels (PDSCH and/or PUSCH) are allocated, the coding rate and/or modulation scheme for the physical channels (PDSCH and/or PUSCH), and/or the transmit power, and the like, from the received channel state information and/or the channel estimate, channel quality, or the like input from the channel measurement unit 3059. Additionally, the scheduling unit 3013 may generate the control information (e.g., the DCI format) in order to control the receiver 305 and/or the transmitter 307 in accordance with a result of the scheduling, and may output the generated information to the control unit 303. Additionally, the scheduling unit 3013 may further determine timing of performing transmission processing and/or reception processing.

Note that in a case that a grant free access scheme is used, the scheduling unit 3013 included in the processing unit 301 need not be provided.

In accordance with the control information originating from the processing unit 301, the control unit 303 generates a control signal for control of the receiver 305 and/or the transmitter 307. The control unit 303 outputs the generated control signal to the receiver 305 and/or the transmitter 307 to control the receiver 305 and/or the transmitter 307.

In accordance with the control signal input from the control unit 303, the receiver 305 demultiplexes, demodulates, and decodes the reception signal received from the terminal apparatus 1 through the transmit and/or receive antenna unit 309, and outputs information resulting from the decoding to the processing unit 301. The radio receiving unit 3057 converts (Down-Converts) an uplink signal received through the transmit and/or receive antenna unit 309 into a baseband signal through orthogonal demodulation, removes unnecessary frequency components, controls the amplification level in such a manner as to suitably maintain a signal level, performs orthogonal demodulation, based on an in-phase component and/or an orthogonal component of the received signal, and converts the resulting orthogonally-demodulated analog signal into a digital signal. The receiver 305 receives the uplink control information.

The radio receiving unit 3057 removes a portion corresponding to a Cyclic Prefix (CP) from the digital signal resulting from the conversion. The radio receiving unit 3057 performs Fast Fourier Transform (FFT) on the signal from which the CP has been removed, extracts a signal in the frequency domain, and outputs the resulting signal to the demultiplexing unit 3055.

The demultiplexing unit 3055 demultiplexes the signal input from the radio receiving unit 3057 into the PUCCH, the PUSCH, and the signal such as the uplink reference signal. Furthermore, the demultiplexing unit 3055 makes a compensation of channels including the PUCCH and the PUSCH from the channel estimate input from the channel measurement unit 3059. Furthermore, the demultiplexing unit 3055 outputs an uplink reference signal resulting from the demultiplexing, to the channel measurement unit 3059.

Note that the demultiplexing by the demultiplexing unit 3055 may be performed based on radio resource allocation information that is determined in advance by the base station apparatus 3 using the radio resource control unit 3011 and that is included in the uplink grant notified to each of the terminal apparatuses 1.

Furthermore, in a case that the PUSCH signal demultiplexed by the demultiplexing unit 3055 is input, the demodulation unit 3053 obtains the specific number of subcarriers based on a power difference. For example, the demodulation unit 3053 calculates the power for each frequency, calculates the power difference for each calculated frequency, and then obtains the specific number of subcarriers. For example, the demodulation unit 3053 calculates the power for each frequency, and obtains the number of subcarriers with power exceeding a prescribed threshold as the specific subcarrier. Additionally, the demodulation unit 3053 performs Inverse Discrete Fourier Transform (IDFT) on the PUSCH, acquires modulation symbols, and demodulates, for each of the modulation symbols of PUCCH and PUSCH, a reception signal in compliance with a modulation scheme predetermined for each number of subcarriers and/or a modulation scheme predetermined regardless of the number of subcarriers and/or a modulation scheme notified with the downlink control information and/or a modulation scheme predetermined for each channel, such as BPSK, QPSK, 16 QAM, or 64 QAM.

Note that the demodulation unit 3053 may obtain the specific number of subcarriers using compressed sensing instead of or/in addition to using the power difference. In a case that the compressed sensing is used, the demodulation unit 3053 may not necessarily use all time samples (or frequency samples) of the received signal. For example, in a case that received OFDM signal includes 64 time samples, the demodulation unit 3053 may reconfigure a signal of all the time samples using less than 64 time samples, and obtain the specific number of subcarriers. The demodulation unit 3053 may select the time sample to be used to obtain the specific number of subcarriers from any portion of the reception signal. For example, by selecting from the latter half of the received OFDM signal, the demodulation unit 3053 can prevent influence of inter-code interference due to a long delay path exceeding the CP. Additionally, the time sample selected by the demodulation unit 3053 may be selected from a plurality of portions.

The demodulation unit 3053 may perform inverse discrete Fourier transform (IDFT) of PUSCH, acquire modulation symbols, and demodulate, for each of the modulation symbols of PUCCH and PUSCH, a reception signal in compliance with a predetermined modulation scheme, such as BPSK, QPSK, 16QAM, and 64QAM, and/or in compliance with a modulation scheme of which the base station apparatus notifies each of the terminal apparatuses 1 in advance by using the uplink grant. Additionally, the demodulation unit 3053 may demultiplex the modulation symbols of multiple pieces of uplink data transmitted on the same PUSCH with the MIMO SM, based on the number of spatial-multiplexed sequences notified in advance with the uplink grant to each of the terminal apparatuses 1 and information indicating the precoding to be performed on the sequences.

Note that the demodulation unit 3053 may obtain the transmission efficiency (modulation scheme, MCS, coding rate) applied to the modulation symbol based on the specific number of subcarriers obtained by the method described above. For example, in a case that the obtained specific number of subcarriers matches with the first number (or the number included in a first group), the demodulation unit 3053 determines that a prescribed modulation scheme (for example, BPSK modulation) has been performed, and can demodulate the modulation symbol. Here, an association between the first number (or first group) and the modulation scheme can be configured by the base station apparatus 3 or/and the terminal apparatus 1 for respective types of the modulation schemes configurable by the base station apparatus 3 or/and the terminal apparatus 1. The base station apparatus 3 can notify the terminal apparatus 1 of the association. The transmitter 107 of the terminal apparatus configures, based on the association, in accordance with the specific number of subcarriers configured by the terminal apparatus 1, the modulation scheme, whereby the terminal apparatus 1 need not notify the base station apparatus 3 of information indicating the modulation scheme configured by the terminal apparatus 1 itself.

Furthermore, the decoding unit 3051 decodes the coded bits of PUCCH and PUSCH, which have been demodulated, at the coding rate in compliance with a coding scheme prescribed in advance, the coding rate being prescribed in advance or being notified in advance with the uplink grant to the terminal apparatus 1 by the base station apparatus 3 itself, and outputs the decoded uplink data and uplink control information to the processing unit 101. In a case that the PUSCH is re-transmitted, the decoding unit 3051 performs the decoding with the coded bits input from the processing unit 301 and retained in an HARQ buffer, and the demodulated coded bits. The channel measurement unit 3059 measures the channel estimate, the channel quality, and the like, based on the uplink reference signal input from the demultiplexing unit 3055, and outputs a result of the measurement to the demultiplexing unit 3055 and/or the processing unit 301.

The transmitter 307 generates the downlink reference signal in accordance with the control signal input from the control unit 303, codes and/or modulates the HARQ indicator, the downlink control information, and the downlink data that are input from the processing unit 301, multiplexes the PHICH, the PDCCH, the PDSCH, and/or the downlink reference signal, and transmits a result of the multiplexing to the terminal apparatus 1 through the transmit and/or receive antenna unit 309.

The coding unit 3071 codes the HARQ indicator, the downlink control information, and/or the downlink data that are input from the processing unit 301, in compliance with the coding scheme predetermined in advance, such as block coding, convolutional coding, or turbo coding, and/or in compliance with the coding scheme determined by the radio resource control unit 3011. The modulating unit 3073 modulates the coded bits input from the coding unit 3071, in compliance with the modulation scheme predetermined in advance, such as BPSK, QPSK, 16 QAM, or 64 QAM, and/or in compliance with the modulation scheme determined by the radio resource control unit 3011.

The downlink reference signal generation unit 3079 generates, as the downlink reference signal, a sequence that is already known to the terminal apparatus 1 and that is acquired in accordance with a rule predetermined in advance, based on the Physical layer Cell Identifier (PCI) for identifying the base station apparatus 3, and the like. The multiplexing unit 3075 multiplexes the modulated modulation symbol of each channel and the generated downlink reference signal. To be more specific, the multiplexing unit 3075 maps the modulated modulation symbol of each channel and the generated downlink reference signal to the resource elements.

The radio transmitting unit 3077 performs Inverse Fast Fourier Transform (IFFT) on the modulation symbol resulting from the multiplexing or the like, generates an OFDM symbol, adds a CP to the generated OFDM symbol, generates a baseband digital signal, converts the baseband digital signal into an analog signal, removes unnecessary frequency components through a lowpass filter, Up-Converts a result of the removal into a signal of a carrier frequency, performs power amplification, and outputs a final result to the transmit and/or receive antenna unit 309 for transmission.

Next, the number of subcarriers and a subcarrier subset according to determination of the number of subcarriers will be described.

FIGS. 5A to 5E are descriptive diagrams illustrating an example of the number of subcarriers and a subcarrier subset according to the first embodiment of the present invention.

The example illustrated in FIG. 5A is an example in a case that the subcarriers are allocated in a communication band such that the subcarriers of the prescribed number are orthogonal, with prescribed subcarrier intervals.

FIGS. 5B to 5E illustrate examples in each of which subcarriers allocated as in FIG. 5A are logically made into a subset.

For example, in a case of determining the number of subcarriers being less than or equal to the prescribed number of subcarriers as the first specific number of subcarriers, and in a case that the number of subcarriers of a subset as illustrated in FIGS. 5B to 5E and the first specific number of subcarriers are the same, the subcarrier number configuration unit 10311 determines any subset among the plurality of subsets as illustrated in FIGS. 5B to 5E as subcarriers of the first specific number of subcarriers.

Furthermore, for example, in a case of determining the number of subcarriers being less than or equal to the prescribed number of subcarriers as the second specific number of subcarriers which is greater than the first specific number of subcarriers, and in a case of being the number of subcarriers which is two times the number of subcarriers of the subset as illustrated in FIGS. 5B to 5E, the subcarrier number configuration unit 10311 determines any two subsets among the plurality of subsets as illustrated in FIGS. 5B to 5E as subcarriers of the second specific number of subcarriers.

Furthermore, for example, in a case of determining the number of subcarriers being less than or equal to the prescribed number of subcarriers as the third specific number of subcarriers rather than the first specific number of subcarriers and the second specific number of subcarriers, and in a case of being the number of subcarriers which is two times the number of subcarriers of the subset as illustrated in FIGS. 5B to 5E, the subcarrier number configuration unit 10311 determines any three subsets among the plurality of subsets as illustrated in FIGS. 5B to 5E as subcarriers of the third specific number of subcarriers.

Furthermore, for example, in a case of determining the number of subcarriers being less than or equal to the prescribed number of subcarriers as the fourth specific number of subcarriers which is greater than the first specific number of subcarriers, the second specific number of subcarriers, and the third specific number of subcarriers and in a case of being the number of subcarriers which is four times the number of subcarriers of the subset as illustrated in FIGS. 5B to 5E, the subcarrier number configuration unit 10311 determines any four subsets among the plurality of subsets as illustrated in FIGS. 5B to 5E as subcarriers of the fourth specific number of subcarriers.

FIG. 6 is a flowchart illustrating an example of a communication method according to the first embodiment of the present invention.

In step S101, the subcarrier number configuration unit 10311 determines, based on transmit power of the terminal apparatus 1 and information indicating the prescribed number of subcarriers, the number of subcarriers to be used for transmission to the specific number of subcarriers which is less than or equal to the prescribed number.

In step S102, the frequency determination unit 10331 determines the frequency to which the subcarriers of the specific number of subcarriers are allocated from among the frequencies in the communication band.

In step S103, the transmission efficiency configuration unit 10313 configures transmission efficiency for the transmit signal from the terminal apparatus 1 to the base station apparatus 3.

Then, the transmission control unit 1033 transmits, via the transmitter 107, using the subcarriers of the specific number of subcarriers to which the transmit signal is allocated, the transmit signal to the base station apparatus 3.

As described above, according to the first embodiment, the terminal apparatus 1 is for communicating with the base station apparatus 3 by using a plurality of subcarriers by a grant free access scheme, the terminal apparatus 1 includes: the configuration unit (subcarrier number configuration unit 10311) configured to configure the number of subcarriers to be used for transmission to the specific number of subcarriers less than or equal to a prescribed number; and transmission (transmitter 107) configured to transmit a transmit signal, in a prescribed communication band, by using subcarriers of the specific number of subcarriers among subcarriers of the prescribed number, in which the transmit signal does not include information configured to indicate the specific number of subcarriers, the transmitter (transmission control unit 1033) performs determination of a frequency in the prescribed communication band to which the subcarriers of the specific number of subcarriers are allocated, and the determination of the frequency in the prescribed communication band is not configured by the base station apparatus 3.

According to such a configuration, flexible variable rate transmission with grant free access can be achieved.

### Second Embodiment

FIG. 7 is a schematic block diagram illustrating an example of a configuration of a control unit 103B of the terminal apparatus 1 according to a second embodiment of the present invention.

The configuration of the terminal apparatus 1 differs from the configuration of the terminal apparatus 1 according to the first embodiment in the control unit 103B. In the second embodiment, portions that are different from the first embodiment will be primarily described.

The control unit 103B is configured to include the configuration unit 1031 and the transmission control unit 1033.

The transmission control unit 1033 is configured to include the frequency determination unit 10331 and a candidate receiving unit 10333.

The candidate receiving unit 10333 receives information indicating the candidate numbers of subcarriers including a plurality of the numbers of subcarriers, which become candidates of the specific number of subcarriers that can be determined by the terminal apparatus 1, from the base station apparatus 3.

Based on the information on the prescribed number of subcarriers included in the control information from the processing unit 101 and the information indicating the candidate numbers of subcarriers from the candidate receiving unit 10333, the subcarrier number configuration unit 10311 determines the number of subcarriers to be used for the terminal apparatus 1 to communicate with the base station apparatus 3 (also referred to as the specific number of subcarriers). The information on the prescribed number of subcarriers is information indicating the prescribed number of subcarriers that the terminal apparatus 1 can use (select or determine) for communication. For example, the prescribed number of subcarriers is the maximum number of subcarriers (maximum number). Note that the prescribed number of subcarriers need not be the maximum number of subcarriers, and the arbitrary number of subcarriers may be reported as the prescribed number from the base station apparatus 3 via the processing unit 101.

The subcarrier number configuration unit 10311 selects, based on the transmit power of the terminal apparatus 1, the number of subcarriers being less than or equal to the prescribed number of subcarriers from among the candidate numbers of subcarriers included in the information indicating the candidate numbers of subcarriers, and determines the selected number as the specific number of subcarriers to be used for communication with the base station apparatus 3. The subcarrier number configuration unit 10311 outputs a signal representing the determined specific number of subcarriers to the transmission efficiency configuration unit 10313.

FIG. 8 is a flowchart illustrating an example of a communication method according to the second embodiment of the present invention.

In step S201, the candidate receiving unit 10333 receives the information indicating the candidate numbers of subcarriers from the base station apparatus 3.

In step S202, the subcarrier number configuration unit 10311 selects, based on the transmit power of the terminal apparatus 1, the information indicating the prescribed number of subcarriers, and the information indicating the candidate numbers of subcarriers, the number of subcarriers to be used for transmission from among the candidate numbers of subcarriers included in the information indicating the candidate numbers of subcarriers, and determines the specific number of subcarriers which is less than or equal to the prescribed number.

In step S203, the frequency determination unit 10331 determines the frequency to which the subcarriers of the specific number of subcarriers are allocated from among the frequencies in the communication band.

In step S303, the transmission efficiency configuration unit 10313 configures transmission efficiency for the transmit signal from the terminal apparatus 1 to the base station apparatus 3.

Then, the transmission control unit 1033 transmits, via the transmitter 107, using the subcarriers of the specific number of subcarriers to which the transmit signal is allocated, the transmit signal to the base station apparatus 3.

As described above, according to the second embodiment, the terminal apparatus 1 is for communicating with the base station apparatus 3 by using a plurality of subcarriers by a grant free access scheme, the terminal apparatus 1 includes: the configuration unit (subcarrier number configuration unit 10311) configured to configure the number of subcarriers to be used for transmission to the specific number of subcarriers less than or equal to a prescribed number; and transmission (transmitter 107) configured to transmit a transmit signal, in a prescribed communication band, by using subcarriers of the specific number of subcarriers among subcarriers of the prescribed number, in which the transmit signal does not include information configured to indicate the specific number of subcarriers, the transmitter (transmission control unit 1033) performs determination of a frequency in the prescribed communication band to which the subcarriers of the specific number of subcarriers are allocated, and the determination of the frequency in the prescribed communication band is not configured by the base station apparatus 3.

According to such a configuration, flexible variable rate transmission with grant free access can be achieved.

### Third Embodiment

FIG. 9 is a schematic block diagram illustrating an example of a configuration of a control unit 103C of the terminal apparatus 1 according to a third embodiment of the present invention.

The configuration of the terminal apparatus 1 differs from the configuration of the terminal apparatus 1 according to the second embodiment in the control unit 103C. In the third embodiment, portions that are different from the first embodiment and the second embodiment will be primarily described.

The control unit 103C is configured to include the configuration unit 1031, the transmission control unit 1033, and a mode configuration unit 1035.

The transmission control unit 1033 is configured to include the frequency determination unit 10331 and the candidate receiving unit 10333.

The candidate receiving unit 10333 receives information indicating the candidate numbers of subcarriers including a plurality of the numbers of subcarriers, which become candidates of the specific number of subcarriers that can be determined by the terminal apparatus 1, from the base station apparatus 3.

The mode configuration unit 1035 configures, based on mode information received from the base station apparatus 3 via the processing unit 101, a mode to any of a first communication mode and a second communication mode. For example, the first communication mode is a mode for performing the contents described in the first embodiment, and the second communication mode is a mode for performing the contents described in the second embodiment. In other words, the terminal apparatus 1 switches, depending on whether the mode is configured to the first communication mode or the second communication mode, between the case of determining the number of subcarriers described in the first embodiment and the case of determining the number of subcarriers described in the second embodiment.

FIG. 10 is a flowchart illustrating an example of a communication method according to the third embodiment of the present invention.

In step S301, the mode configuration unit 1035 receives the mode information from the base station apparatus 3 via the processing unit 101.

In step S302, the terminal apparatus 1 switches, depending on whether the communication mode indicated by the mode information is the first communication mode or the second communication mode, between performing processing from step S303 to step S305 and performing processing from step S306 to step S309. In a case that the communication mode indicated by the mode information is the first communication mode (step S302; YES), the terminal apparatus 1 performs processing from step S303 to step S305. On the other hand, in a case that the communication mode indicated by the mode information is not the first communication mode, that is, in a case that the mode is the second communication mode (step S302; NO), the terminal apparatus 1 performs processing from step S306 to step S309.

Here, processing from step S303 to step S305 is the same as processing from step S101 to step S103 according to the first embodiment, and thus description thereof is omitted.

Furthermore, processing from step S306 to step S309 is the same as processing from step S201 to step S204 according to the second embodiment, and thus description thereof is omitted.

As described above, according to the third embodiment, the terminal apparatus 1 is for communicating with the base station apparatus 3 by using a plurality of subcarriers by a grant free access scheme, the terminal apparatus 1 includes: the configuration unit (subcarrier number configuration unit 10311) configured to configure the number of subcarriers to be used for transmission to the specific number of subcarriers less than or equal to a prescribed number; and transmission (transmitter 107) configured to transmit a transmit signal, in a prescribed communication band, by using subcarriers of the specific number of subcarriers among subcarriers of the prescribed number, in which the transmit signal does not include information configured to indicate the specific number of subcarriers, the transmitter (transmission control unit 1033) performs determination of a frequency in the prescribed communication band to which the subcarriers of the specific number of subcarriers are allocated, and the determination of the frequency in the prescribed communication band is not configured by the base station apparatus 3.

Furthermore, in a case of being configured to the first communication mode, the terminal apparatus 1 can configure the specific number of subcarriers to an arbitrary value by the method described in the first embodiment or the second embodiment, and in a case of being configured to the second communication mode, the terminal apparatus 1 can obtain the specific number of subcarriers from the base station apparatus 3. The terminal apparatus 1 configured to the second communication mode can obtain the specific number of subcarriers from the scheduling information transmitted by the base station apparatus 3 (for example, information reported by the DCI).

According to such a configuration, flexible variable rate transmission with grant free access can be achieved.

Note that each program running on the base station apparatus 3 and/or the terminal apparatus 1 according to an aspect of the present invention may be a program that controls a Central Processing Unit (CPU) and the like, such that the program causes a computer to operate in such a manner as to realize the functions described in each of the above-described embodiments and modifications according to an aspect of the present invention. The information handled in each of these apparatuses is temporarily accumulated in a Random Access Memory (RAM) while being processed, and thereafter, the information is stored in various types of Read Only Memory (ROM) such as a flash ROM and a Hard Disk Drive (HDD), and read by the CPU to be modified or rewritten, as necessary.

Note that the terminal apparatus 1 and the base station apparatus 3 according to each of the above-described embodiments and modifications may be partially achieved by a computer. In that case, this configuration may be realized by recording a program for realizing such control functions on a computer-readable recording medium and causing a computer system to read the program recorded on the recording medium for execution.

Note that it is assumed that the “computer system” mentioned here refers to a computer system built into the terminal apparatus 1 or the base station apparatus 3, and the computer system includes an OS and hardware components such as a peripheral apparatus. Furthermore, the “computer-readable recording medium” refers to a portable medium such as a flexible disk, a magneto-optical disk, a ROM, a CD-ROM, and the like, and a storage apparatus such as a hard disk built into the computer system.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the base station apparatus 3 according to each of the above-described embodiments and modifications may be achieved as an aggregation (apparatus group) including multiple apparatuses. Each of the apparatuses configuring such an apparatus group may include some and/or all portions of each function and/or each functional block of the base station apparatus 3 according to each of the above-described embodiments and modifications. The apparatus group may include each general function and/or each functional block of the base station apparatus 3. Furthermore, the terminal apparatus 1 according to the above-described embodiments can also communicate with the base station apparatus 3 as the aggregation.

Furthermore, the base station apparatus 3 according to each of the above-described embodiments and modifications may serve as an Evolved Universal Terrestrial Radio Access Network (EUTRAN). Furthermore, the base station apparatus 3 according to each of the above-described embodiments and modifications may have some and/or all portions of the functions of a node higher than an eNodeB.

Furthermore, some or all portions of each of the terminal apparatus 1 and the base station apparatus 3 according to each of the above-described embodiments and modifications may be typically achieved as an LSI which is an integrated circuit or may be achieved as a chip set. The functional blocks of each of the terminal apparatus 1 and the base station apparatus 3 according to each of the above-described embodiments and modifications may be individually achieved as a chip, or some or all of the functional blocks may be integrated into a chip. The circuit integration technique is not limited to LSI, and the integrated circuits for the functional blocks may be realized as dedicated circuits and/or a multi-purpose processor. Furthermore, in a case where with advances in semiconductor technology, a circuit integration technology with which an LSI is replaced appears, it is also possible to use an integrated circuit based on the technology.

Furthermore, according to each of the above-described embodiments and modifications, the terminal apparatus is described as one example of a communication apparatus, but the aspect of the present invention is not limited to this, and can be applied to a fixed-type and/or a stationary-type electronic apparatus installed indoors or outdoors, for example, a terminal apparatus or a communication apparatus, such as an audio-video (AV) apparatus, a kitchen apparatus, a cleaning or washing machine, an air-conditioning apparatus, office equipment, a vending machine, an automobile, a bicycle, and other household apparatuses.

The embodiments and modifications as the aspect of the present invention have been described in detail above referring to the drawings, but the specific configuration is not limited to the embodiments and modifications and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and modifications and having mutually the same effects, are substituted for one another is also included in the technical scope of the present invention.

For example, the aspect of the present invention may be achieved by combining some or all of the above-described embodiments and the modifications.

### INDUSTRIAL APPLICABILITY

An aspect of the present invention can be utilized, for example, in a communication system, communication equipment (for example, a cellular phone apparatus, a base station apparatus, a radio LAN apparatus, or a sensor device), an integrated circuit (for example, a communication chip), or a program.

### REFERENCE SIGNS LIST

1 Terminal apparatus
3 Base station apparatus
101 Processing unit
1011 Radio resource control unit
1013 Scheduling information interpretation unit
103A, 103B, 103C Control unit
10311 Subcarrier number configuration unit
10313 Transmission efficiency configuration unit
1033 Transmission control unit
10331 Frequency determination unit
10333 Candidate receiving unit
1035 Mode configuration unit
105 Receiver
1051 Decoding unit
1053 Demodulation unit
1055 Demultiplexing unit
1057 Radio receiving unit
1059 Channel measurement unit
107 Transmitter
1071 Coding unit
1073 Modulating unit
1075 Multiplexing unit
1077 Radio transmitting unit
1079 Uplink reference signal generation unit
301 Processing unit
3011 Radio resource control unit
3013 Scheduling unit
303 Control unit
305 Receiver
3051 Decoding unit
3053 Demodulation unit
3055 Demultiplexing unit
3057 Radio receiving unit
3059 Channel measurement unit
307 Transmitter
3071 Coding unit
3073 Modulating unit
3075 Multiplexing unit
3077 Radio transmitting unit
3079 Downlink reference signal generation unit
309 Transmit and/or receive antenna unit

1. A terminal apparatus for communicating with a base station apparatus by using a plurality of subcarriers by a grant free access scheme, the terminal apparatus comprising:
a configuration unit configured to configure the number of the plurality of subcarriers to be used for transmission to the specific number of the plurality of subcarriers less than or equal to the prescribed number of the plurality of subcarriers; and
a transmitter configured to transmit, in a prescribed communication band, a transmit signal by using the plurality of subcarriers of the specific number among the plurality of subcarriers of the prescribed number,
wherein the transmit signal does not include information for indicating the specific number of the plurality of subcarriers,
the transmitter performs determination of a frequency in the prescribed communication band to which the plurality of subcarriers of the specific number are allocated, and
the determination of the frequency in the prescribed communication band is not configured by the base station apparatus.

2. The terminal apparatus according to claim 1,
wherein the prescribed number is obtained from the base station apparatus.

3. The terminal apparatus according to claim 1,
wherein the configuration unit configures transmission efficiency of the transmit signal based on the specific number of the plurality of subcarriers.

4. The terminal apparatus according to claim 1,
wherein the configuration unit configures the specific number of the plurality of subcarriers based on transmit power of the transmit signal.

5. The terminal apparatus according to claim 1,
wherein a candidate of the frequency in the prescribed communication band is configured by the base station apparatus.

6. The terminal apparatus according to claim 5,
wherein the specific number of the plurality of subcarriers includes the first number of the plurality of subcarriers and the second number of the plurality of subcarriers greater than the first number of the plurality of subcarriers, and
the candidate of the frequency in the prescribed frequency band to which the configuration unit allocates the plurality of subcarriers of the first number is a subset of the candidate of the frequency in the prescribed frequency band to which the plurality of subcarriers of the second number are allocated.

7. The terminal apparatus according to claim 1, the terminal apparatus further comprising:
a receiver configured to receive a signal including control information for indicating that any of at least two transmission modes is configured, the at least two transmission modes including a first transmission mode that allows the specific number of the plurality of subcarriers to be configured and a second transmission mode in which the specific number of the plurality of subcarriers is preconfigured,
wherein the configuration unit
configures, in a case that the first transmission mode is configured, the specific number of the plurality of subcarriers to a selected value, and
configures, in a case that the second transmission mode is configured, the specific number of the plurality of subcarriers to a value configured by the base station apparatus.

8. A base station apparatus for communicating with a terminal apparatus by using a plurality of subcarriers by a grant free access scheme, the base station apparatus comprising:
a receiver configured to receive a signal transmitted from the terminal apparatus; and
a signal demodulation unit configured to obtain the number of the plurality of subcarriers based on the signal.

9. The base station apparatus according to claim 8,
wherein the signal demodulation unit obtains transmission efficiency configured for the signal based on the number of the plurality of subcarriers.

10. The base station apparatus according to claim 9, the base station apparatus further comprising:
a transmitter configured to transmit a signal including information for indicating a candidate of the number of the plurality of subcarriers configurable by the terminal apparatus, to the terminal apparatus.

11. The base station apparatus according to claim 10,
wherein the transmitter transmits a signal including control information for indicating that any of at least two transmission modes is configured, the at least two transmission modes including a first transmission mode that allows the number of the plurality of subcarriers to be configured and a second transmission mode in which the number of the plurality of subcarriers is preconfigured.

12. The base station apparatus according to claim 8,
wherein the signal demodulation unit obtains the number of the plurality of subcarriers by using compressed sensing.

13. The base station apparatus according to claim 8,
wherein the signal demodulation unit obtains the number of the plurality of subcarriers by using reception power determination using a prescribed threshold.

14. A communication method used by a terminal apparatus for communicating with a base station apparatus by using a plurality of subcarriers by a grant free access scheme, the communication method comprising the steps of:
configuring the number of the plurality of subcarriers to be used for transmission to the specific number of the plurality of subcarriers less than or equal to the prescribed number of the plurality of subcarriers; and
transmitting a transmit signal, in a prescribed communication band, by using the plurality of subcarriers of the specific number among the plurality of subcarriers of the prescribed number,
wherein the transmit signal does not include information for indicating the specific number of the plurality of subcarriers,
in the transmitting, determination of a frequency in the prescribed communication band to which the plurality of subcarriers of the specific number are allocated is performed, and
the determination of the frequency in the prescribed communication band is not configured by the base station apparatus.

15. (canceled)

16. (canceled)

17. (canceled)
